(19) United States
(12) Patent Application Publication
(10) Pub. No.: US 2018/0003903 A1
(43) Pub. Date: Jan. 4, 2018

(54) Cable Connector

(71) Applicant: Google Inc., Mountain View, CA (US)

(72) Inventors: Jamyuen Ko, San Jose, CA (US); Hong Liu, Palo Alto, CA (US); Ryohei Urata, San Carlos, CA (US); Zuowei Shen, Los Altos, CA (US)

(73) Assignee: Google Inc., Mountain View, CA (US)

(21) Appl. No.: 15/196,669

(22) Filed: Jun. 29, 2016

(51) Int. Cl. G02B 6/38; G02B 6/32

(52) U.S. Cl. CPC G02B 6/3881; G02B 6/3885; G02B 6/32; G02B 6/3821; G02B 6/387

(57) ABSTRACT

An optical connector assembly includes a spring, a ferrule, a first housing, and a second housing connected to the first housing. The ferrule includes a ferrule body and a lens. The ferrule body defines a fiber receiver configured to receive optical fibers of an optical cable and a first spring receiver configured to receive the spring. The lens is arranged to optically communicate light propagated by the received optical fibers for free-space optical communication. The first housing defines a first opening configured to slidably receive and guide the ferrule for movement along a first longitudinal axis. The second housing defines a second opening configured to receive the optical cable therethrough along a second longitudinal axis, and a second spring receiver configured to receive the spring. The spring biases movement of the ferrule in the first housing away from the second housing.

### TECHNICAL FIELD

This disclosure relates to cable connectors, and more particularly to optical cable connectors.

### BACKGROUND

Connector assemblies are used in a wide range of industries and applications to couple a first transmission member, such as a first wire or cable, to a second transmission member, such as a second wire or cable. In some applications, a connector assembly is utilized to transmit a signal, such as light or electricity, from the first transmission member to the second transmission member. For example, a fiber optic connector assembly may transmit light through a lens from a first optical fiber to a second optical fiber. Some connector assemblies include alignment features in order to ensure that the connector assembly properly mates with a mating connector assembly.

### SUMMARY

One aspect of the disclosure provides an optical connector assembly including a spring, a ferrule, a first housing, and a second housing connected to the first housing. The ferrule includes a ferrule body and a lens. The ferrule body defines a fiber receiver configured to receive optical fibers of an optical cable and a first spring receiver configured to receive the spring. The lens is arranged to optically communicate light propagated by the received optical fibers for free-space optical communication. The first housing defines a first longitudinal axis and a first opening therethrough along the first longitudinal axis. The first opening is configured to slidably receive and guide the ferrule for movement along the first longitudinal axis. The second housing defines a second longitudinal axis, a second opening therethrough along the second longitudinal axis, and a second spring receiver configured to receive the spring. The second opening is configured to receive the optical cable therethrough. The spring biases movement of the ferrule in the first housing away from the second housing.

Implementations of the disclosure may include one or more of the following optional features. In some implementations, the fiber receiver defines an array of grooves configured to receive and arrange the optical fibers in a linear side-by-side fiber arrangement. The ferrule may include a fiber fix plate configured to engage the ferrule body and hold the received optical fibers in the fiber receiver. The fiber receiver may define a fiber-engagement surface complimentary to the fiber fix plate, the received optical fibers held between the fiber-engagement surface and the fiber fix plate. The fiber-engagement surface may be substantially planar, and the fix plate may define a substantially planar surface complementary to the fiber engagement surface. In some examples, the fiber receiver defines a lateral surface and a medial surface. The lateral surface and the medial surface may extend from the fiber-engagement surface such that the lateral surface, the medial surface, and the fiber-engagement surface define a channel. The fiber receiver may include a first flange and a second flange. The first flange may extend from the lateral surface and may be configured to hold the fiber fix plate in the channel. The second flange may extend from the medial surface and may be configured to hold the fiber fix plate in the channel.

In some implementations, the ferrule body defines at least one alignment feature for guiding connection with a mating ferrule receiver. The at least one alignment feature may define a groove. The received optical fibers may extend in a direction substantially parallel to a longitudinal axis, and the first spring receiver may include at least one flange extending in a direction transverse to the longitudinal axis. The lens may include a lens array supported by the ferrule body.

Another aspect of the disclosure provides a method that includes mating optical fibers of an optical cable to a ferrule, inserting the ferrule into a first housing defining a first longitudinal axis and a first opening therethrough along the first longitudinal axis, and connecting a second housing to the first housing. The ferrule includes a ferrule body and a lens. The ferrule body defines a fiber receiver configured to receive the optical fibers of the optical cable, and a first spring receiver configured to receive a spring. The lens is arranged to optically communicate light propagated by the received optical fibers for free-space optical communication. The first opening of the first housing is configured to slidably receive and guide the ferrule for movement along the first longitudinal axis. The second housing defines a second longitudinal axis, a second opening therethrough along the second longitudinal axis, and a second spring receiver. The second opening is configured to receive the optical cable therethrough. The spring biases movement of the ferrule in the first housing away from the second housing.

This aspect may include one or more of the following optional features. In some implementations, the fiber receiver defines an array of grooves configured to receive and arrange the optical fibers in a linear side-by-side fiber arrangement. The method may further include engaging a fiber fix plate to the ferrule body to hold the received optical fibers in the fiber receiver. The fiber receiver may define a fiber-engagement surface complimentary to the fiber fix plate. The received optical fibers may be held between the fiber-engagement surface and the fix plate. The fiber-engagement surface may be substantially planar, and wherein the fix plate may define a substantially planar surface complementary to the fiber engagement surface.

In some examples, the fiber receiver defines a lateral surface and a medial surface, the lateral surface and the medial surface extending form the fiber-engagement surface such that the lateral surface, the medial surface, and the fiber-engagement surface define a channel. The fiber receiver may include a first flange and a second flange. The first flange may extend from the lateral surface and configured to hold the fiber fix plate in the channel. The second flange may extend from the medial surface and configured to hold the fiber fix plate in the channel. The ferrule body may define at least one alignment feature for guiding connection with a mating ferrule receiver. At least one alignment feature may define a groove. The received optical fibers may extend in a direction substantially parallel to a longitudinal axis, and wherein the first spring receiver may include at least one flange extending in a direction transverse to the longitudinal axis. The lens may include a lens array supported by the ferrule body.

Yet another aspect of the disclosure provides a connector including a spring, a ferrule, and a housing configured to receive the ferrule. The ferrule defines a longitudinal axis and has a fiber receiver and a first spring receiver. The fiber receiver is configured to receive an optical fiber extending substantially parallel to the longitudinal axis. The first spring receiver is configured to receive the spring. The housing has a second spring receiver configured to receive the spring. The spring is arranged to bias movement of the ferrule along the longitudinal axis.

This aspect may include one or more of the following optional features. In some implementations, the connector includes a fiber fix plate configured to engage the ferrule and hold the received optical fiber in the fiber receiver. The fiber receiver may define a fiber-engagement surface complimentary to the fiber fix plate. The received optical fiber may be held between the fiber-engagement surface and the fiber fix plate. The ferrule may include a lens optically coupled to the fiber. In some examples, the fiber receiver defines a groove configured to receive and seat the fiber for the optical coupling with the lens. The ferrule may define at least one alignment feature for guiding the connection with a mating ferrule receiver.

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1 is a perspective view of an example connector assembly.

FIG. 2 is an exploded view of the connector assembly of FIG. 1.

FIG. 3A is a perspective view of an example plug subassembly of a connector assembly.

FIG. 3B is a perspective view of an example plug of a plug subassembly.

FIG. 3C is another perspective view of an example plug of a plug subassembly.

FIG. 4A is a perspective view of a portion of an example connector assembly.

FIG. 4B is a cross sectional view of an example connector assembly.

FIG. 5 provides a flowchart illustrating an example method according to principles of the present disclosure.

Like reference symbols in the various drawings indicate like elements.

### DETAILED DESCRIPTION

Connector assemblies are utilized in a wide range of industries and applications to couple a first transmission member, such as a first wire or cable, for example, to a second transmission member, such as a second wire or cable, for example. In some implementations, a connector assembly is utilized to transmit a signal, such as light or electricity, for example, from the first transmission member to the second transmission member. For example, the connector assembly may transmit light from the first transmission member, through a lens, to a second transmission member. An improved connector assembly can help to ensure the accurate transmission of signals from the first transmission member to the lens, and from the lens to the second transmission member. For example, an improved connector assembly can align the lens relative to the connector assembly in order to ensure that signals are accurately transmitted through the connector assembly.

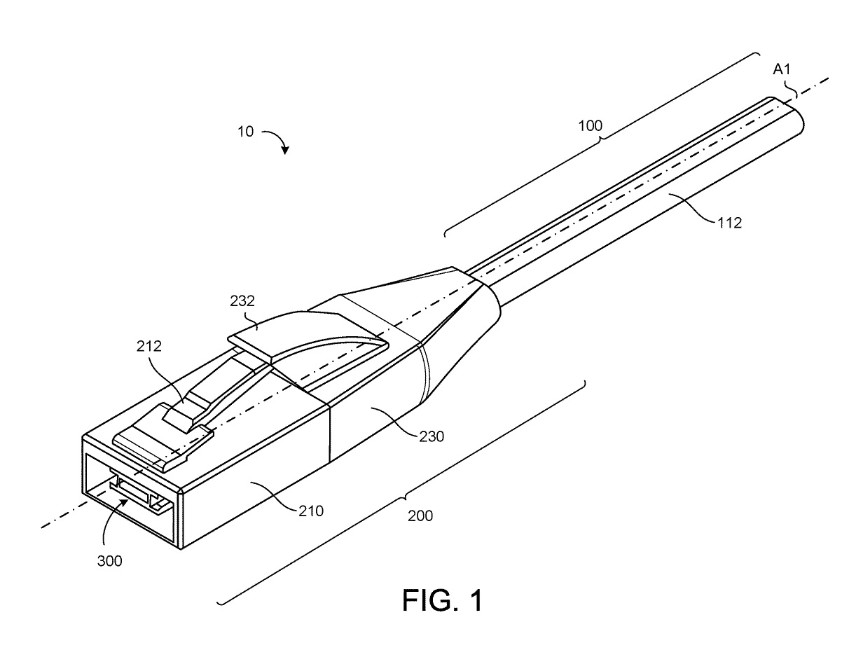

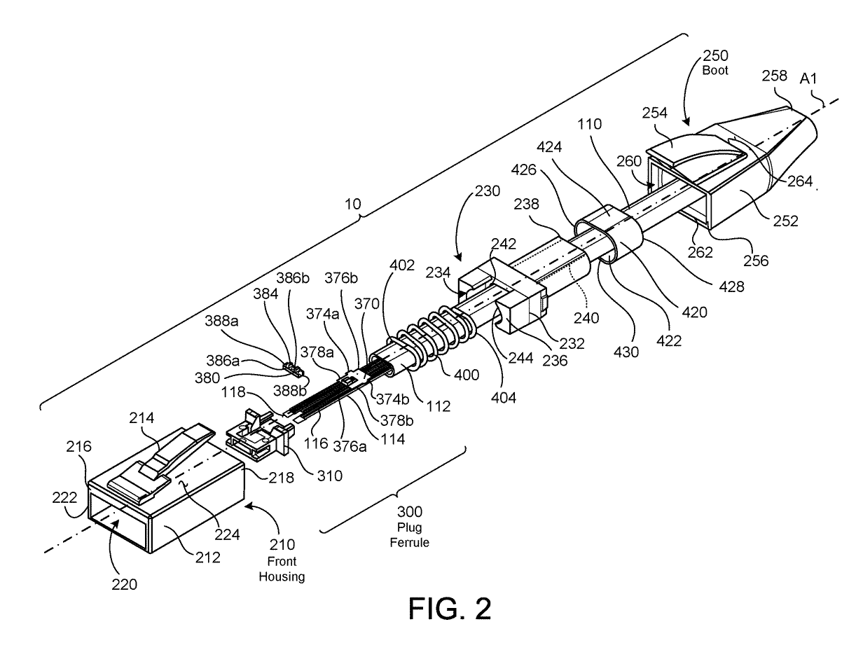

FIGS. 1 and 2 illustrate an example connector assembly 10 for coupling to a mating connector assembly (not shown). In some implementations, the connector assembly 10 is coupled to the mating connector assembly for transmitting signals from the connector assembly 10 to the mating connector assembly, or vice versa.

The connector assembly 10 includes a cable 100 and a connector 200 coupled to the cable 100. The cable 100 may include a jacket 112 housing one or more strands 114. In some implementations, the connector assembly 10 includes, or otherwise defines, an optical connector assembly for transmitting light signals. In this regard, the cable 100 may be described herein as a fiber optic cable 100 having one or more optical fibers 114. The connector assembly 10 may, however, include other types of connector assemblies for transmitting other types of signals (e.g., electricity).

As illustrated in FIG. 2, in some implementations, the jacket 112 surrounds a plurality of optical fibers 114. Each optical fiber 114 may include a cover 116 surrounding a core 118 (e.g., glass, crystalline, plastic, etc.). At least a portion of the jacket 112, the fibers 114, the cover 116, and the core 118 may extend from the connector 200 in a direction parallel to a longitudinal axis A1 defined by the connector assembly 10.

In some implementations, the connector 200 includes a front housing 210, a back housing 230, a boot 250, a plug ferrule 300, a biasing member 400, and a crimp ring 420. As will be explained in more detail below, the connector 200 may be coupled to the cable 100 in order to transmit a signal from the connector 200 to the cable 100, and vice versa. For example, the plug ferrule 300 may be coupled to at least one of the cover 116 and the core 118 in order to transmit a signal from the core 118 to the plug ferrule 300.

The front housing 210 includes a body 212 and a locking mechanism 214. The body 212 may include a proximal end 216 and a distal end 218 opposite the proximal end 216. In some implementations, the body 212 defines a passage 220 extending from a proximal opening 222 defined by the proximal end 216 to a distal opening (not shown) defined by the distal end 218. In this regard, the passage 222 extends in a direction substantially parallel to the longitudinal axis A1 from the proximal end 216 to the distal end 218. The locking mechanism 214 may extend from, and be supported by, an outer surface 224 of the body 212. In an assembled implementation, the locking mechanism 214 is coupled to a portion of the mating connector assembly in order to secure the front housing 210 to the mating connector assembly.

The back housing 230 includes a body 232 and a spring receiver 234. The body 232 may include a proximal end 236 and a distal end 238 opposite the proximal end 236. In some implementations, the body 232 defines a passage 240 extending from a proximal opening 242 to a distal opening (not shown) defined by the distal end 238. In this regard, the passage 240 extends in a direction substantially parallel to the longitudinal axis A1 from the proximal end 236 to the distal end 238. The spring receiver 234 may define an aperture 244 defined by the proximal end 236 of the body 232. In some implementations, the spring receiver 234 defines a counterbore concentrically disposed relative to the proximal opening 242 of the passage 240.

The boot 250 includes a boot body 252 and a locking mechanism receiver 254. The boot body 252 may include a proximal end 256 and a distal end 258 opposite the proximal end 256. In some implementations, the boot body 252 defines a passage 260 extending from a proximal opening 262 defined by the proximal end 256 to a distal opening (not shown) defined by the distal end 258. In this regard, the passage 260 extends in a direction substantially parallel to the longitudinal axis A1 from the proximal end 256 to the distal end 258. The locking mechanism receiver 254 may extend from, and be supported by, an outer surface 264 of the boot body 252.

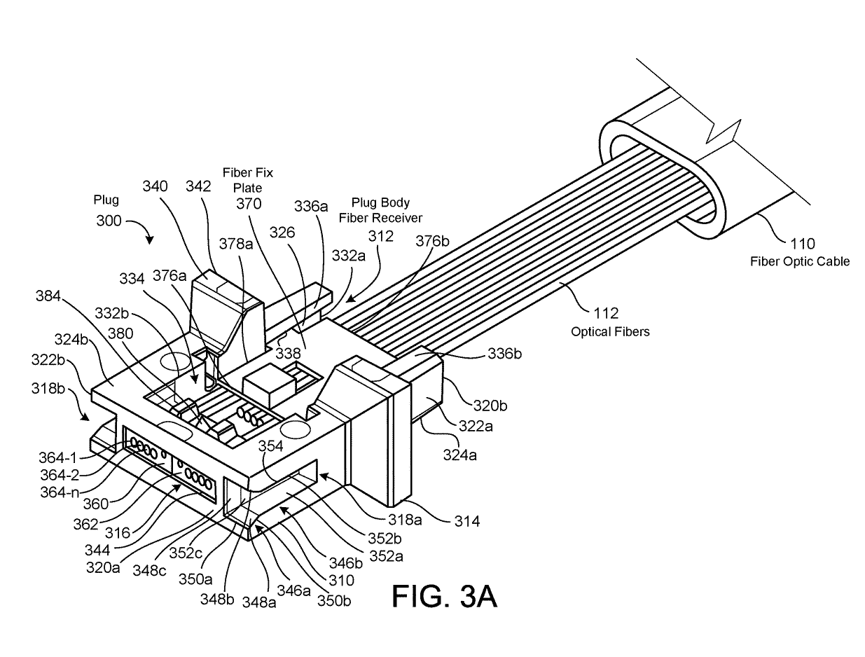

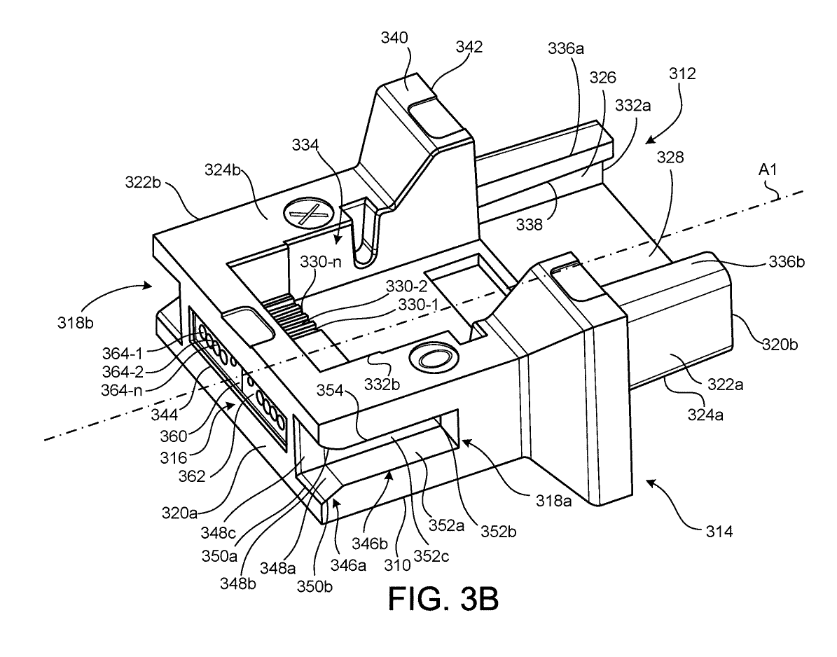

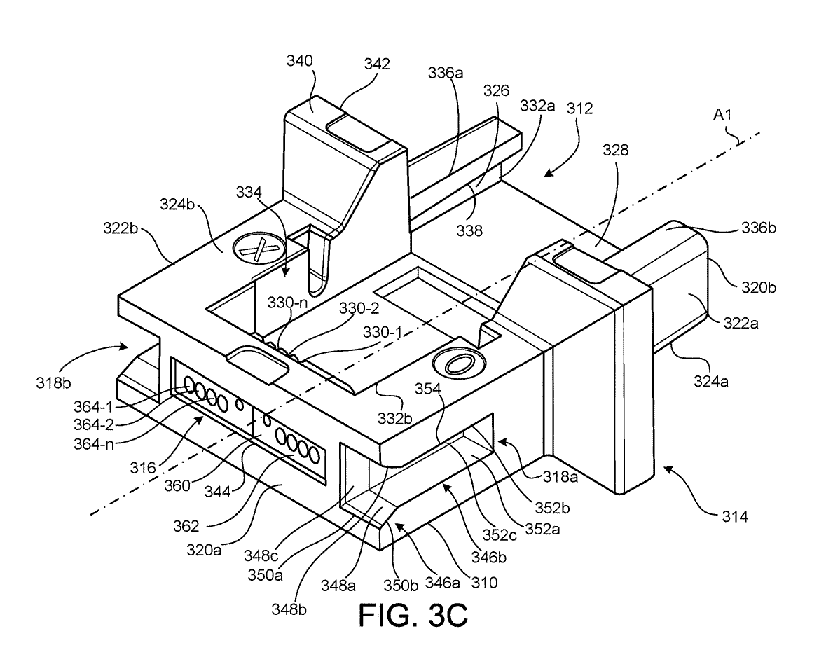

In the example shown in FIG. 3A, the plug ferrule 300 includes a plug body 310, a lens assembly 360, a fix plate 370, and a fix block 380. In some implementations, the plug body 310 includes a fiber receiver 312, a spring receiver 314, a lens receiver 316, a first alignment feature 318a, and a second alignment feature 318b.

As illustrated in FIGS. 3B and 3C, the plug body 310 may extend (i) in a direction along the longitudinal axis A1 from a first end 320a to a second end 320b, (ii) in a direction transverse to (e.g., perpendicular) the longitudinal axis A1 from a first side 322a to a second side 322b, and (iii) in a direction transverse to (e.g., perpendicular) the longitudinal axis A1 from a third side 324a to a fourth side 324b.

In some implementations, the fiber receiver 312 defines a lateral surface 326, a medial surface opposing the lateral surface 326, a fiber-engaging surface 328 extending from the lateral surface 326 to the medial surface, and one or more grooves 330-1, 330-2, . . . 330-n to receive the optical fibers 114. The lateral surface 326, the medial surface, and the fiber-engaging surface 328 define (i) a first opening 332a in the second end 320b of the plug body 310 and (ii) a second opening 332b in the fourth side 324b of the plug body 310, such that the lateral surface 326, the medial surface, and the fiber-engaging surface 328 define a channel 334. In some implementations, the one or more grooves 330-1, 330-2, . . . 330-n define an array of grooves 330-1, 330-2, . . . 330-n disposed in a linear, side-by-side arrangement. In this regard, each of the grooves 330-1, 330-2, . . . 330-n extends in a direction substantially parallel to the longitudinal axis A1. In some implementations, each of the grooves 330-1, 330-2, . . . 330-n defines a V-shaped profile. The profile of the grooves 330-1, 330-2, . . . 330-n may, however, define other shapes (e.g., U-shaped, C-shaped, or rectangular-shaped).

The plug body 310 may further include a lateral flange 336a and a medial flange 336b. The lateral flange 336a extends from the lateral surface 326 and defines a lateral plate-engaging surface 338 facing, and substantially parallel to, the fiber-engaging surface 328. The medial flange 336b extends from the medial surface and defines a medial plate-engaging surface (not shown) facing, and substantially parallel to, the fiber engaging surface 328. In some implementations, the lateral surface 326 is parallel to, and coplanar with, the medial surface.

The spring receiver 314 may define a flange 340 extending from one or more of the first side 322a, the second side 322b, the third side 324a, and the fourth side 324b of the plug body 310. In some implementations, the flange 340 extends from the first, second, third, and fourth sides 322a, 322b, 324a, and 324b of the plug body 310. The flange 340 defines a spring-engaging surface 342 extending in a direction transverse to the longitudinal axis A1 from one or more of the first, second, third, and fourth sides 322a, 322b, 324a, and 324b. In some implementations, the spring-engaging surface 342 extends from one or more of the first, second, third, and fourth sides 322a, 322b, 324a, and 324b in a direction substantially perpendicular to the longitudinal axis A1. Other arrangements are possible as well. For example, the spring-engaging surface 342 may extend from one or more of the first, second, third, and fourth sides 322a, 322b, 324a, and 324b at angle other than 90 degrees from the longitudinal axis A1.

The lens receiver 316 may include an aperture 344 defined by the first end 320a of the plug body 310. In some implementations, the aperture 344 extends through the plug body 310 such that the aperture 344 is in communication with the channel 334. While the aperture 344 is shown as defining a generally rectangular shape, the aperture 344 may define other shapes as well.

The first alignment feature 318a may be substantially similar to the second alignment feature 318b. In this regard, the first alignment feature 318a may be disposed proximate the first side 322a of the plug body 310, and the second alignment feature 318b may be disposed proximate the second side 322b of the plug body 310. References herein to the first alignment feature 318a apply equally to the second alignment feature 318b, except as otherwise shown or described.

The first alignment feature 318a may include an entry portion 346a and a guide portion 346b extending from the entry portion 346a in a direction substantially parallel to the longitudinal axis A1. In some implementations, the entry portion 346a defines a first alignment surface 348a, a second alignment surface 348b opposing the first alignment surface 348a, and a third alignment surface 348c extending from the first alignment surface 348a to the second alignment surface 348b. The first alignment surface 348a, the second alignment surface 348b, and the third alignment surface 348c define (i) a first opening 350a in the first end 320a of the plug body 310 and (ii) a second opening 350b in the first side 322a of the plug body 310, such that the first, second, and third alignment surfaces 348a, 348b, and 348c define a channel. In some implementations, the first, second, and/or third alignment surfaces 348a, 348b, and 348c are tapered. In this regard, the first, second, and/or third alignment surfaces may extend at a non-orthogonal angle relative to the first end 320a of the plug body 310 such that the entry portion 346a is flared relative to the guide portion 346b.

The guide portion 346b of the first alignment feature 318a may define a first guide surface 352a extending from the first alignment surface 348a, a second guide surface 352b extending from the second alignment surface 348b, and a third guide surface 352c extending from the third alignment surface 348c and from the first guide surface 352a to the second guide surface 352b. The first guide surface 352a, the second guide surface 352b, and the third guide surface 352c may define a first opening 354 in the first side 322a of the plug body 310, such that the first, second, and third alignment surfaces 348a, 348b, and 348c define a channel in communication with the channel of the entry portion 346a. In some implementations, the guide portion 346b defines a substantially rectangular profile extending in a direction substantially parallel to the longitudinal axis A1. The guide portion 346b may, however, define other shapes (e.g., U-shaped, C-shaped, or V-shaped) extending in the direction substantially parallel to the longitudinal axis A1.

The lens assembly 360 may include a lens housing 362 and one or more lens elements 364-1, 364-2, . . . 364-n. Moreover, at least a portion of the lens assembly 360 may be disposed within the lens receiver 316. For example, the lens housing 362 may be secured within the aperture 344 using a press-fit, an adhesive, or any other suitable technique. As illustrated in FIG. 3A, in some implementations, the lens assembly 360 includes eight lens elements 364-n. Each lens element 364-n extends through the lens housing 362 in a direction substantially parallel to the longitudinal axis A1. In some implementations, the lens elements 364-1, 364-2, . . . 364-n define an array of lens elements 364-1, 364-2, . . . 364-n disposed in a linear, side-by-side arrangement. In this regard, the quantity and arrangement of the lens elements 364-1, 364-2, . . . 364-n are substantially the same as the quantity and arrangement of the grooves 330-1, 330-2, . . . 330-n of the fiber receiver 312.

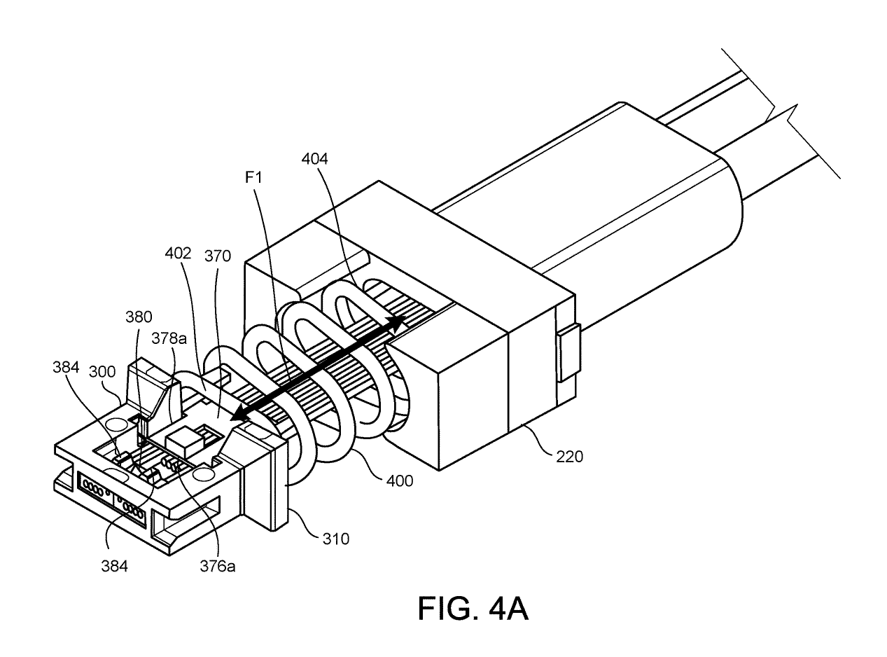

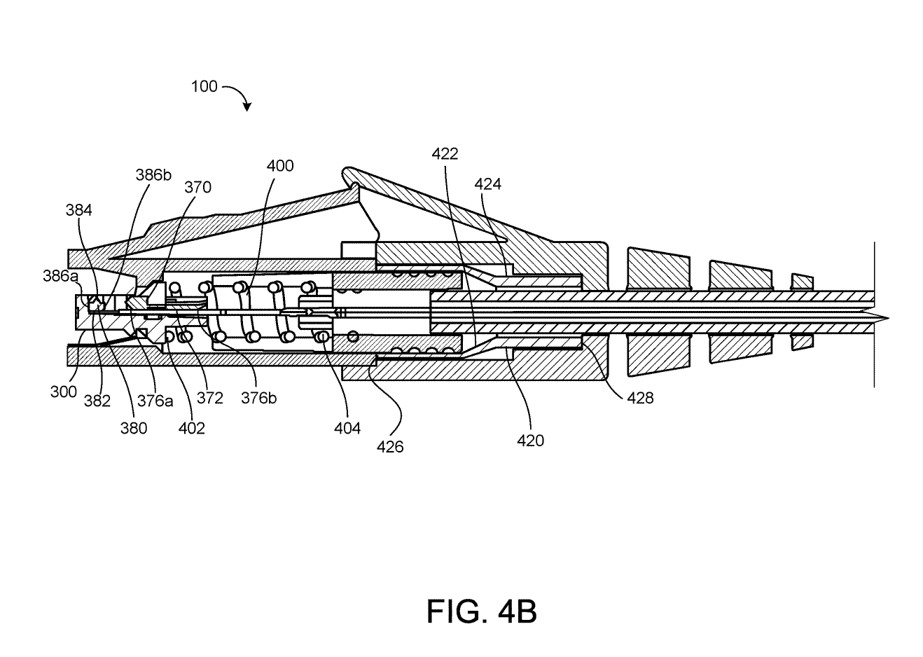

With reference to FIGS. 2 and 4B, the fix plate 370 may include a fiber-engaging surface 372, a lateral tab 374a, and a medial tab 374b. The fiber-engaging surface 372 extends from a proximal end 376a to a distal end 376b along the longitudinal axis A1, and from a lateral side 378a to a medial side 378b in a direction transverse to the longitudinal axis A1. In some implementations, the fiber-engaging surface 372 is substantially planar. The lateral tab 374a extends from the lateral side 378a in a direction transverse to the longitudinal axis A1, and the medial tab 374b extends from the medial side 378b in a direction transverse to the longitudinal axis A1.

The fix block 380 may include a fiber-engaging surface 382 and one or more placement features 384. The fiber-engaging surface 382 extends from a proximal end 386a to a distal end 386b along the longitudinal axis A1, and from a lateral side 388a to a medial side 388b in a direction transverse to the longitudinal axis A1. The placement features 384 extend from the fix block 380 in a direction transverse to the longitudinal axis A1.

With reference to FIGS. 4A and 4B, the biasing member 400 may define a first end 402 and a second end 404. In some implementations, the biasing member 400 includes a helical compression spring configured to produce a biasing force F1 in a direction substantially parallel to the longitudinal axis A1. The biasing member 400 may, however, include other materials and/or constructs configured to produce the biasing force F1. For example, the biasing member 400 may include a polymeric material.

As illustrated in FIG. 4B, the crimp ring 420 may include an inner surface 422, an outer surface 424, a proximal end 426, and a distal end 428. The inner surface 422 defines a through-hole 430 extending along the longitudinal axis A1 from the proximal end 426 to the distal end 428.

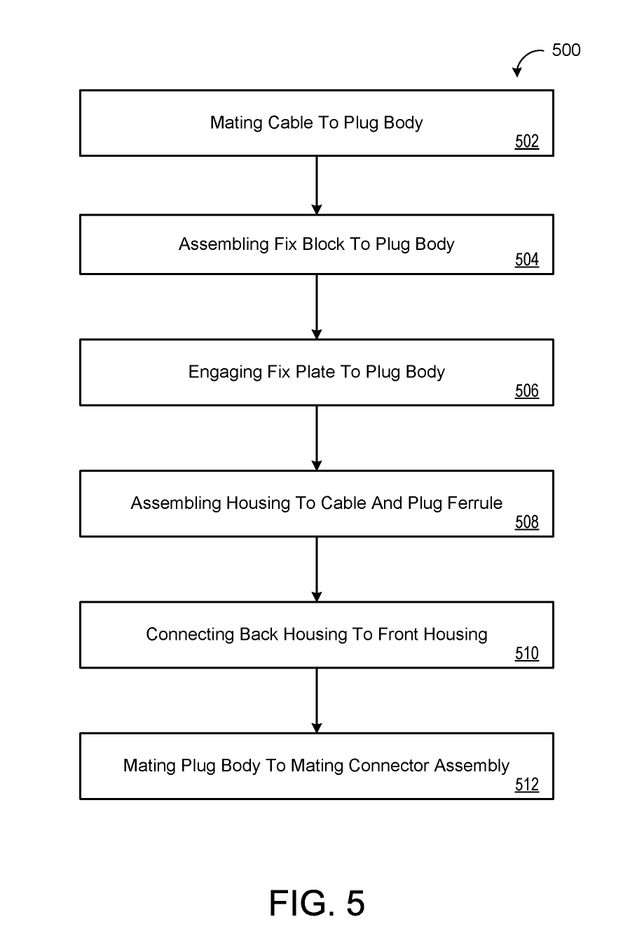

FIG. 5 illustrates an example arrangement of operations for a method 500 of assembling the connector assembly 10. With additional reference to FIGS. 1-4B, at operation 502, the method includes mating the cable 110 to the plug body 310. For example, at operation 502, the method 500 may include extending the cable 110 along the longitudinal axis A1 (i) through the passage 260 of the boot 250, (ii) through the through-hole 430 of the crimp ring 420, (iii) through the passage 240 of the back housing 230, (iv) through the biasing member 400, and (v) into the fiber receiver 312 of the plug body 310. In some implementations, at operation 502, the method 500 includes disposing each optical fiber 114 in a respective groove 330-1, 330-2, . . . 330-n of the fiber receiver 312, such that each optical fiber 114 engages one of the lens elements 364-1, 364-2, . . . 364-n of the lens assembly 360.

At operation 504, the method 500 includes assembling the fix block 380 to the plug body 310. For example, at operation 504, the method may include extending the fix block 380 through the second opening 332b, in a direction transverse to the longitudinal axis A1, such that the fiber-engaging surface 382 engages one or more of the optical fibers 114. In this regard, the fix block 380 may be aligned with the grooves 330-1, 330-2, . . . 330-n to secure the optical fibers 114 within the grooves 330-1, 330-2, . . . 330-n. In some implementations, at operation 504, the method 500 includes securing the fix block 380 within the fiber receiver 312 using an adhesive, a friction fit configuration, or other suitable fastening technique.

At operation 506, the method 500 includes engaging the fix plate 370 to the plug body 310. For example, at operation 506, the method 500 may include translating the fix plate 370 through the first opening 332a, in a direction substantially parallel to the longitudinal axis A1, such that the fiber-engaging surface 372 slidably engages one or more of the optical fibers 114. In this regard, at operation 506, the fix plate 370 may be disposed within the fiber receiver 312 such that the lateral tab 374a is disposed between the lateral flange 336a and the fiber-engaging surface 328 of the plug body 310, and the medial tab 374b is disposed between the medial flange 336b and the fiber engaging surface 328 of the plug body 310. In some implementations, at operation 506, the lateral plate-engaging surface 338 of the lateral flange 336a slidably engages the lateral tab 374a of the fix plate 370, and the medial plate-engaging surface of the medial flange 336b slidably engages the medial tab 374b of the fix plate 370.

At operation 508, the method 500 includes assembling at least one of the front housing 210 and the back housing 230 to the cable 110 and to the plug ferrule 300. In some implementations, at operation 508, the method 500 includes securing the back housing 230 of the connector 200 to the cable 110, and inserting the plug ferrule 300 into at least one of the front housing 210 and the back housing 230 such that the plug ferrule 300 is movable within the passage 220 along the longitudinal axis A1. For example, at operation 508, the method 500 may include securing the back housing 230 to the jacket 112 of the cable 110. In some implementations, at operation 508, the back housing 230 may be disposed within the through-hole 430 of the crimp ring 420, and the crimp ring 420 may be crimped, or otherwise constricted, around the back housing 230 to secure the back housing 230 to the cable 110.

At operation 510, the method 500 includes connecting the back housing 230 to the front housing 210 such that the plug body 310 is mated with the front housing 210. In particular, at operation 510, the method 500 may include securing the back housing 230 to the front housing 210 such that the plug body 310 is disposed within the passage 220 of the front housing 210. In some implementations, at operation 510, the method 500 includes securing the back housing 230 to the front housing 210 such that the biasing member 400 biasingly engages the spring receiver 234 of the back housing 230 and the spring receiver 314 of the plug body 310. In particular, at operation 510, the first end 402 of the biasing member 400 may engage the spring receiver 234, and the second end 404 of the biasing member 400 may engage the spring receiver 314 such that the biasing member 400 produces the force F1 on the spring receivers 234 and 314 to bias the plug body 310 away from the back housing 230.

At operation 512, the method 500 includes mating the plug body 310 to a portion of a mating connector assembly. For example, at operation 512, the method 500 may include mating a portion (e.g., an alignment pin(s)) of the mating connector with the first alignment feature 318a and/or the second alignment feature 318b of the plug body 310. In particular, at operation 512, the method 500 may include translating a portion of the mating connector within the first alignment feature 318a and/or the second alignment feature 318b in a direction substantially parallel to the longitudinal axis A1. In some implementations, the method 500 may include applying a force F2 on the plug body 310 with the mating connector assembly. The force F2 may be equal to and opposite the force F1 of the biasing member 400.

A number of implementations have been described. Nevertheless, it will be understood that various modifications may be made without departing from the spirit and scope of the disclosure. Accordingly, other implementations are within the scope of the following claims.

What is claimed is:

1. An optical connector assembly comprising:
a spring;
a ferrule comprising:
a ferrule body defining:
a fiber receiver configured to receive optical fibers of an optical cable; and
a first spring receiver configured to receive the spring; and
a lens arranged to optically communicate light propagated by the received optical fibers for free-space optical communication;
a first housing defining a first longitudinal axis and a first opening therethrough along the first longitudinal axis, the first opening configured to slidably receive and guide the ferrule for movement along the first longitudinal axis; and
a second housing connected to the first housing, the second housing defining:
a second longitudinal axis;
a second opening therethrough along the second longitudinal axis, the second opening configured to receive the optical cable therethrough; and
a second spring receiver configured to receive the spring, the spring biasing movement of the ferrule in the first housing away from the second housing.

2. The optical connector assembly of claim 1, wherein the fiber receiver defines an array of grooves configured to receive and arrange the optical fibers in a linear side-by-side fiber arrangement.

3. The optical connector assembly of claim 1, wherein the ferrule further comprises a fiber fix plate configured to engage the ferrule body and hold the received optical fibers in the fiber receiver, the fiber receiver defining a fiber-engagement surface complimentary to the fiber fix plate, the received optical fibers held between the fiber-engagement surface and the fiber fix plate.

4. The optical connector assembly of claim 3, wherein the fiber-engagement surface is substantially planar, and wherein the fix plate defines a substantially planar surface complementary to the fiber engagement surface.

5. The optical connector assembly of claim 3, wherein the fiber receiver defines a lateral surface and a medial surface, the lateral surface and the medial surface extending from the fiber-engagement surface such that the lateral surface, the medial surface, and the fiber-engagement surface define a channel.

6. The optical connector assembly of claim 5, wherein the fiber receiver includes a first flange and a second flange, the first flange extending from the lateral surface and configured to hold the fiber fix plate in the channel, the second flange extending from the medial surface and configured to hold the fiber fix plate in the channel.

7. The optical connector assembly of claim 1, wherein the ferrule body defines at least one alignment feature for guiding connection with a mating ferrule receiver.

8. The optical connector assembly of claim 1, wherein the at least one alignment feature defines a groove.

9. The optical connector assembly of claim 1, wherein the received optical fibers extend in a direction substantially parallel to a longitudinal axis, and wherein the first spring receiver comprises at least one flange extending in a direction transverse to the longitudinal axis.

10. The optical connector assembly of claim 1, wherein the lens comprises a lens array supported by the ferrule body.

11. A method comprising:
mating optical fibers of an optical cable to a ferrule, the ferrule comprising:
a ferrule body defining:
a fiber receiver configured to receive the optical fibers of the optical cable; and
a first spring receiver configured to receive a spring; and
a lens arranged to optically communicate light propagated by the received optical fibers for free-space optical communication;
inserting the ferrule into a first housing defining a first longitudinal axis and a first opening therethrough along the first longitudinal axis, the first opening configured to slidably receive and guide the ferrule for movement along the first longitudinal axis; and
connecting a second housing to the first housing, the second housing defining:
a second longitudinal axis;
a second opening therethrough along the second longitudinal axis, the second opening configured to receive the optical cable therethrough; and
a second spring receiver configured to receive the spring, the spring biasing movement of the ferrule in the first housing away from the second housing.

12. The method of claim 11, wherein the fiber receiver defines an array of grooves configured to receive and arrange the optical fibers in a linear side-by-side fiber arrangement.

13. The method of claim 11, further comprising engaging a fiber fix plate to the ferrule body to hold the received optical fibers in the fiber receiver, the fiber receiver defining a fiber-engagement surface complimentary to the fiber fix plate, the received optical fibers held between the fiber-engagement surface and the fix plate.

14. The method of claim 13, wherein the fiber-engagement surface is substantially planar, and wherein the fix plate defines a substantially planar surface complementary to the fiber engagement surface.

15. The method of claim 13, wherein the fiber receiver defines a lateral surface and a medial surface, the lateral surface and the medial surface extending from the fiber-engagement surface such that the lateral surface, the medial surface, and the fiber-engagement surface define a channel.

16. The method of claim 15, wherein the fiber receiver includes a first flange and a second flange, the first flange extending from the lateral surface and configured to hold the fiber fix plate in the channel, the second flange extending from the medial surface and configured to hold the fiber fix plate in the channel.

17. The method of claim 11, wherein the ferrule body defines at least one alignment feature for guiding connection with a mating ferrule receiver.

18. The method of claim 11, wherein the at least one alignment feature defines a groove.

19. The method of claim 11, wherein the received optical fibers extend in a direction substantially parallel to a longitudinal axis, and wherein the first spring receiver comprises at least one flange extending in a direction transverse to the longitudinal axis.

20. The method of claim 11, wherein the lens comprises a lens array supported by the ferrule body.

21. A connector comprising:
a spring;
a ferrule defining a longitudinal axis and having a fiber receiver and a first spring receiver, the fiber receiver configured to receive an optical fiber extending substantially parallel to the longitudinal axis, the first spring receiver configured to receive the spring; and
a housing configured to receive the ferrule, the housing having a second spring receiver configured to receive the spring, the spring arranged to bias movement of the ferrule along the longitudinal axis.

22. The connector of claim 21, further comprising a fiber fix plate configured to engage the ferrule and hold the received optical fiber in the fiber receiver, the fiber receiver defining a fiber-engagement surface complimentary to the fiber fix plate, the received optical fiber held between the fiber-engagement surface and the fiber fix plate.

23. The connector of claim 21, wherein the ferrule includes a lens optically coupled to the fiber.

24. The connector of claim 23, wherein the fiber receiver defines a groove configured to receive and seat the fiber for the optical coupling with the lens.

25. The connector of claim 21, wherein the ferrule defines at least one alignment feature for guiding connection with a mating ferrule receiver.
